(19) United States
(12) Patent Application Publication
(10) Pub. No.: US 2026/0307749 A1
(43) Pub. Date: Oct. 8, 2026

(54) MODULAR ALL-TERRAIN MINIBIKE WITH INTERCHANGEABLE WHEEL, SKI AND TRACK ASSEMBLIES

(71) Applicant: Heath Dyer, Bellefontaine, OH (US)

(72) Inventor: Heath Dyer, Bellefontaine, OH (US)

(21) Appl. No.: 19/636,065

(22) Filed: Apr. 1, 2026

Related U.S. Application Data
(60) Provisional application No. 63/782,662, filed on Apr. 3, 2025.

(51) Int. Cl. B62D 55/04; B62D 55/02; B62D 55/30; B62J 1/02; B62J 35/00; B62K 11/04; B62K 23/02; B62K 25/08; B62M 9/00; B62M 27/02

(52) U.S. Cl. CPC B62D 55/04; B62D 55/02; B62D 55/30; B62K 11/04; B62K 23/02; B62M 9/00; B62M 27/02; B62J 1/02; B62J 35/00; B62K 25/08; B62M 2027/021; B62M 2027/022; B62M 2027/023; B62M 2027/025; B62M 2027/026; B62M 2027/028

(57) ABSTRACT

A convertible all-terrain minibike that includes a frame assembly supporting an engine and a drivetrain configured to transmit rotational power to a rear propulsion system. The convertible all-terrain minibike is selectively configurable between multiple terrain-operating modes through interchangeable components. A front steering assembly is selectively (i.e., removably) mountable as either a front wheel assembly or a front ski assembly, while the rear propulsion system is selectively (i.e., removably) mountable as either a rear wheel assembly or a rear track assembly. The modular configuration enables operation across diverse terrain types including dirt, gravel, mud, sand, snow, and ice. The drivetrain can include a chain-driven or belt-driven system and can further incorporate a centrifugal clutch for automatic engagement. The convertible all-terrain minibike can be provided as a complete vehicle or as a conversion kit including interchangeable components.

### CROSS-REFERENCE TO RELATED APPLICATION

The present application claims priority to, and the benefit of, U.S. Provisional Application No. 63/782,662 which was filed on Apr. 3, 2025 and is incorporated herein by reference in its entirety.

### FIELD OF THE INVENTION

The present invention generally relates to off-road vehicles. More specifically, the present invention relates to a modular minibike apparatus configured to selectively receive interchangeable front and rear terrain-engaging assemblies to improve traction and stability during operation on surfaces such as dirt, mud, snow, ice, sand, and gravel. The convertible all-terrain minibike comprises a frame assembly supporting an engine and a drivetrain configured to transmit rotational power to a rear propulsion system. The rear propulsion system can include either a rear wheel assembly or a rear track assembly configured to engage the ground surface and provide enhanced traction. A front steering assembly is provided and is selectively configurable as either a front wheel assembly or a front ski assembly configured to provide directional control on firm or soft terrain. The convertible all-terrain minibike further includes a handlebar assembly for steering, a seat assembly for supporting a rider, and a foot support assembly. The interchangeable assemblies are removably mounted to the frame assembly using fasteners, thereby enabling conversion between configurations while maintaining a compact and efficient vehicle structure. Accordingly, the present disclosure makes specific reference thereto. Nonetheless, it is to be appreciated that aspects of the present invention are also equally applicable to other like applications, devices, and methods of manufacture.

### BACKGROUND

By way of background, riding trails using conventional minibikes, motorcycles, or all-terrain vehicles (ATVs) can be difficult and potentially hazardous when traversing uneven or rough terrain such as mud, snow, ice, sand, or loose gravel. Such environments often present reduced traction and unstable ground conditions, which can adversely affect vehicle control and rider safety. Conventional vehicles typically rely on standard pneumatic tires that are susceptible to damage, including punctures, tearing, or loss of air pressure, particularly when operated over sharp objects, debris, or rugged terrain.

Additionally, standard tire configurations may provide insufficient traction on soft or slippery surfaces, leading to slippage, reduced maneuverability, and loss of stability. Loss of traction can result in decreased control of the vehicle, increasing the likelihood of accidents, falls, or other hazardous situations that may cause injury to the rider. Accordingly, individuals desire an improved minibike system that is capable of maintaining traction and stability across a wide range of terrain types.

Therefore, there exists a long-felt need in the art for an improved all-terrain minibike that can operate safely and effectively across a wide variety of terrain conditions including mud, snow, ice, sand, gravel, and uneven off-road surfaces. There is a further need for a minibike that provides enhanced traction and stability in low-traction environments where conventional pneumatic tires may slip, lose grip, or become damaged. Additionally, there exists a need for a minibike system that reduces the likelihood of tire puncture, deflation, or failure when traversing harsh or debris-laden terrain. Moreover, there is a need for a modular minibike apparatus that enables a user to selectively adapt the vehicle for different terrain types without requiring significant mechanical expertise or permanent modification. Finally, there is a need for A convertible all-terrain minibike that improves rider safety and control by maintaining consistent ground engagement and reducing the risk of loss of balance or crash during operation.

The subject matter disclosed and claimed herein, in one embodiment, comprises A convertible all-terrain minibike configured to provide enhanced mobility across multiple terrain types through a modular and interchangeable component system. The convertible all-terrain minibike includes a frame assembly supporting an engine and a drivetrain configured to transmit rotational power to a rear propulsion system. The rear propulsion system is selectively configurable as either a rear wheel assembly or a rear track assembly configured to engage a ground surface and provide increased traction. A front steering assembly is also provided and is selectively configurable as either a front wheel assembly or a front ski assembly, thereby enabling improved steering control on both firm and soft terrain. The interchangeable assemblies are removably attached to the convertible all-terrain minibike using fasteners, enabling a user to convert between configurations with minimal tools and effort.

In one embodiment, the drivetrain includes a drive sprocket and a driven sprocket coupled by a drive chain and can further include a centrifugal clutch assembly configured to automatically engage upon reaching a predetermined engine speed. The rear track assembly can include a continuous track belt supported by idler wheels. The front ski assembly can include an elongated body having a curved forward portion and can be coupled to a front fork via a shock absorber configured to dampen impacts and maintain stability during operation on soft terrain.

In this manner, the convertible all-terrain minibike of the present invention overcomes deficiencies associated with conventional minibikes and off-road vehicles. The modular configuration enables rapid conversion between wheel-based and track-based systems, enabling a single vehicle platform to be used across diverse environmental conditions. The convertible all-terrain minibike provides improved traction, stability, and maneuverability while reducing the risk of tire failure and loss of control. As a result, the convertible all-terrain minibike enhances rider safety, increases operational versatility, and eliminates the need for multiple specialized vehicles for different terrain types.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an all-terrain minibike. The convertible all-terrain minibike includes a frame assembly that provides structural support for the vehicle. An engine is mounted to the frame assembly and is configured to provide rotational power for propulsion. A drivetrain is operatively coupled to the engine, wherein the drivetrain includes a drive sprocket, a driven sprocket, and a chain member configured to transfer rotational power from the engine to a rear propulsion system. The rear propulsion system is selectively configurable as either a rear wheel assembly or a rear track assembly configured to engage a ground surface. A front steering assembly is also provided and is selectively configurable as either a front wheel assembly or a front ski assembly. The front steering assembly and the rear propulsion system are interchangeably mountable to the frame assembly, thereby enabling operation of the convertible all-terrain minibike on multiple terrain types.

In one embodiment, a modular all-terrain minibike system includes a minibike platform having a frame assembly, an engine mounted to the frame assembly, and a drivetrain configured to transmit rotational power from the engine. The system further includes a front mounting interface coupled to the frame assembly and a rear mounting interface coupled to the frame assembly. The front mounting interface includes attachment points configured to receive fasteners, and the rear mounting interface similarly includes attachment points configured to receive fasteners. A front wheel assembly and a front ski assembly are each removably attachable to the front mounting interface. A rear wheel assembly and a rear track assembly are each removably attachable to the rear mounting interface. The front and rear assemblies are interchangeable, such that the convertible all-terrain minibike platform can be selectively configured between a wheel-based configuration and a track-based configuration for operation over different terrain conditions.

In another embodiment, the invention provides a method of converting a minibike from a wheel-based configuration to an all-terrain configuration and the method includes removing a front wheel assembly from a front fork of the convertible all-terrain minibike. The method further includes installing a front ski assembly onto the front fork in place of the removed front wheel assembly. A rear wheel assembly is then removed from a rear portion of the convertible all-terrain minibike. A rear track assembly is subsequently attached to the rear portion of the convertible all-terrain minibike. The installed front ski assembly and rear track assembly enable operation of the convertible all-terrain minibike on soft or low-traction terrain.

In a further embodiment, the convertible all-terrain minibike includes a centrifugal clutch assembly positioned between the engine and the drive sprocket. The centrifugal clutch assembly is configured to automatically engage when the engine reaches a predetermined rotational speed. The centrifugal clutch assembly further enables automatic engagement and disengagement of the drivetrain without requiring manual clutch actuation.

In still another embodiment, the rear track assembly includes a continuous track belt configured to engage the ground surface. The rear track assembly further includes at least one idler wheel.

In some embodiments, the ski assembly includes an elongated body having a curved forward portion configured to facilitate movement over snow or soft terrain. The ski assembly is coupled to the frame assembly through a front fork and includes a shock absorber. The shock absorber is configured to dampen vertical movement and improve ride stability during operation.

In one aspect, the front ski assembly is configured to be installed by removing a front axle and securing the ski assembly using the front axle and at least one additional fastener. The ski assembly is thereby removably attached to the front mounting interface.

In another embodiment, the rear track assembly is configured to be secured to the convertible all-terrain minibike platform using a plurality of mounting fasteners. The rear track assembly further includes a drive axle configured to receive rotational power from the drivetrain.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side-elevational view of one embodiment of all-terrain minibike of the present invention in accordance with the disclosed structure;

FIG. 2 illustrates a side perspective view of another embodiment of the convertible all-terrain minibike of the present invention in accordance with the disclosed structure;

FIG. 3 illustrates a side perspective view of the convertible all-terrain minibike in a wheel-based configuration adapted for operation on firmer terrain such as dirt, gravel, and paved surfaces;

FIG. 4 illustrates an enlarged perspective view of the front portion of the convertible all-terrain minibike of the present invention, showing installation of the front ski assembly, in accordance with the disclosed structure; and

FIG. 5 illustrates a flow diagram depicting steps of converting the convertible all-terrain minibike from a wheel-based configuration to a track and ski-based configuration, in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long-felt need in the art for an improved all-terrain minibike that can operate safely and effectively across a wide variety of terrain conditions including mud, snow, ice, sand, gravel, and uneven off-road surfaces. There is a further need for a minibike that provides enhanced traction and stability in low-traction environments where conventional pneumatic tires may slip, lose grip, or become damaged. Additionally, there exists a need for a minibike system that reduces the likelihood of tire puncture, deflation, or failure when traversing harsh or debris-laden terrain. Moreover, there is a need for a modular minibike apparatus that enables a user to selectively adapt the vehicle for different terrain types without requiring significant mechanical expertise or permanent modification. Finally, there is a need for A convertible all-terrain minibike that improves rider safety and control by maintaining consistent ground engagement and reducing the risk of loss of balance or crash during operation.

The present invention, in one exemplary embodiment, provides a method of converting a minibike from a wheel-based configuration to an all-terrain configuration and the method includes removing a front wheel assembly from a front fork of the convertible all-terrain minibike. The method further includes installing a front ski assembly onto the front fork in place of the removed front wheel assembly. A rear wheel assembly is then removed from a rear portion of the convertible all-terrain minibike. A rear track assembly is subsequently attached to the rear portion of the convertible all-terrain minibike. The installed front ski assembly and rear track assembly enable operation of the convertible all-terrain minibike on soft or low-traction terrain.

Reference will now be made in detail to the present preferred embodiments of the invention, examples of which are illustrated in the accompanying drawings. Wherever possible, the same reference numerals are used in the drawings and the description to refer to the same or like parts.

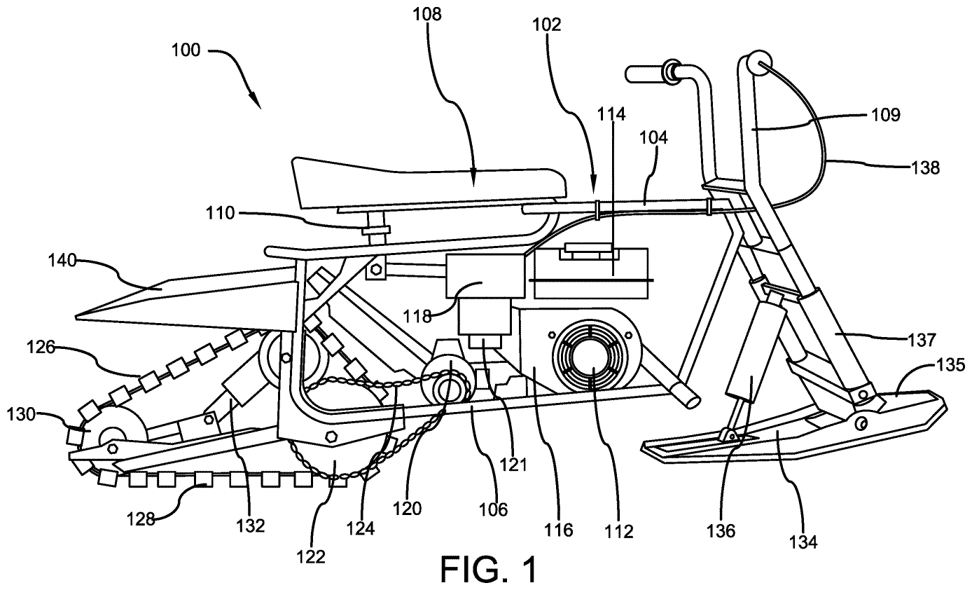

Referring initially to the drawings, FIG. 1 illustrates a side-elevational view of one embodiment of all-terrain minibike of the present invention in accordance with the disclosed structure. The convertible all-terrain minibike 100 of the present invention is configured to operate on a plurality of terrain types including snow, mud, sand, gravel, dirt, and uneven off-road surfaces. The convertible all-terrain minibike 100 incorporates an interchangeable front steering assembly, enabling the convertible all-terrain minibike 100 to maintain traction and stability in environments where conventional wheeled minibikes may lose mobility.

More specifically, the convertible all-terrain minibike 100 generally includes a frame assembly 102 forming the primary structural support of the vehicle. The frame assembly 102 is preferably constructed from a plurality of welded tubular members and is configured to support and interconnect the major components of the convertible all-terrain minibike 100.

A seat assembly 108 is mounted to the frame assembly 102 and is configured to support a rider. The seat assembly 108 is positioned along an upper portion of the frame assembly 102 and can include a spring-supported seat mount 110 that provides cushioning and vibration reduction during operation on uneven terrain.

A handlebar assembly 104 is positioned at a forward portion of the frame assembly 102 and includes handle grips 109 to enable a user to control steering and operation of the convertible all-terrain minibike 100. A control cable 138 extends from the handlebar assembly 104 to the engine 118 for controlling throttle or braking functions. The frame assembly 102 further supports a foot support assembly 106 for providing a stable platform for the rider's feet during operation.

A power unit comprising an engine 118 is mounted to the frame assembly 102. The engine 118 is preferably a small gasoline-powered engine and includes a fuel tank 114 positioned above the engine housing. The fuel tank 114 is configured to store a supply of liquid fuel, such as gasoline, for delivery to the engine 118. The engine 118 further includes a recoil starter assembly 116 for initiating operation and an exhaust system 112 for directing combustion gases away from the engine.

The engine 118 functions as the primary power source for propelling the convertible all-terrain minibike 100. The engine 118 is preferably a compact internal combustion engine, such as a single-cylinder, four-stroke gasoline engine, configured to provide sufficient torque and power for operation across varied terrain conditions including snow, mud, and uneven surfaces. It should be noted that the engine 118 can further include standard components such as an air intake system, carburetor, ignition module, and cooling features, such as air-cooling fins, for safe operation under varying environmental conditions.

The engine 118 is operatively connected to a drivetrain system including a drive sprocket 120 and a rear or driven sprocket 122 coupled via a drive chain or belt 124. The drivetrain system transfers rotational power from the engine 118 to a rear propulsion system. In one embodiment, the engine output shaft can include a centrifugal clutch assembly 121 between the engine 118 and the drive sprocket 120, such that the drive sprocket 120 is driven only when the engine reaches a predetermined rotational speed, thereby enabling automatic engagement and disengagement of the drivetrain without requiring manual clutch operation. The drive chain or belt 124 can be a roller chain or equivalent power transmission belt configured to engage corresponding teeth formed on the drive sprocket 120 and the driven sprocket 122.

The rear propulsion system includes a rear track assembly 126 configured to engage the ground surface and provide enhanced traction. The rear track assembly 126 includes a continuous track supported by at least one rear idler wheel 128 and guided by a rear track support structure 132. A track tensioner 130 is provided to maintain proper tension of the rear track assembly 126 during operation.

A deflector panel 140 is positioned above at least a portion of the rear track assembly 126 and is configured to shield the rider and components from debris, snow, or mud displaced by the track during operation.

At the forward end of the convertible all-terrain minibike 100, a front ski assembly 134 is mounted to a front fork assembly 137 and is configured to provide directional control when operating on snow or other soft terrain. The front ski assembly 134 is supported by at least one shock absorber 136 which dampens impacts and improves ride stability. The front ski assembly 134 is configured as an elongated ground-engaging member adapted to provide flotation and directional control of the convertible all-terrain minibike 100 when operated on snow, ice, sand, or other soft terrain. The ski 135 is preferably constructed from a durable, low-friction material, such as high-density polyethylene (HDPE), composite polymer, or metal with a coated surface, to reduce drag and resist wear. The ski 135, in combination with the shock absorber 136, provides improved stability, flotation, and maneuverability compared to a conventional front wheel when operating in snow or loose terrain environments.

In operation, the engine 118 drives the drive sprocket 120, which transmits power through the drive chain or belt 124 to the driven sprocket 122, thereby rotating the rear track assembly 126. The rear track assembly 126 engages the terrain to propel the convertible all-terrain minibike 100 forward, while steering is controlled through the handlebar assembly 104 and front ski assembly 134.

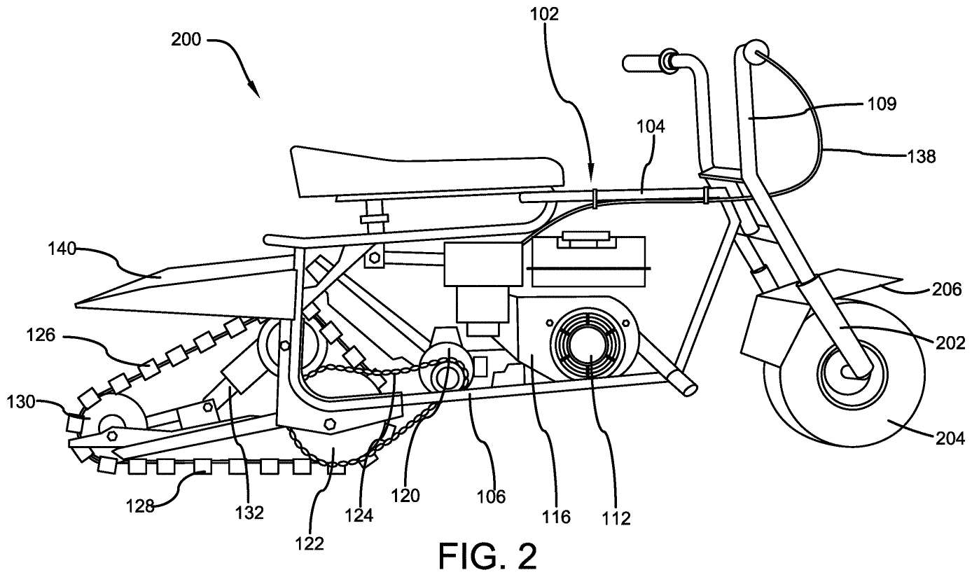

FIG. 2 illustrates a side perspective view of another embodiment of the convertible all-terrain minibike of the present invention in accordance with the disclosed structure. In the present embodiment, the convertible all-terrain minibike 200 retains the frame assembly 102, engine 118, fuel tank 114, drivetrain components including the drive sprocket 120, driven sprocket 122, and drive chain or belt 124, as well as the rear track assembly 126 with associated components such as the rear idler wheel 128, track tensioner 130, rear track support structure 132, and deflector panel 140, as previously described.

The forward terrain-engaging assembly in FIG. 2 comprises a front wheel assembly 202 in place of the front ski assembly. The front wheel assembly 202 includes a tire 204 mounted on a rim and rotatably supported by a front fork. The tire 204 is configured for operation on firmer terrain such as dirt, gravel, or paved surfaces. A front fender 206 is positioned above at least a portion of the tire 204 and is configured to shield the rider and components from debris displaced by the rotating wheel.

The front wheel assembly 202 is operatively connected to the handlebar assembly 104 via the steering fork, enabling directional control in a manner similar to a conventional minibike. The handle grips 109 and associated control cable 138 remain configured to control throttle and/or braking functions as previously described.

Accordingly, FIG. 2 demonstrates the modular structure of the convertible all-terrain minibike 100, wherein the front ski assembly of FIG. 1 can be replaced with the front wheel assembly 202 to adapt the vehicle for operation on different terrain types. The interchangeable configuration improves the utility of the convertible all-terrain minibike 100 by enabling efficient use across both soft and firm ground conditions without requiring substantial modification to the underlying frame or drivetrain systems.

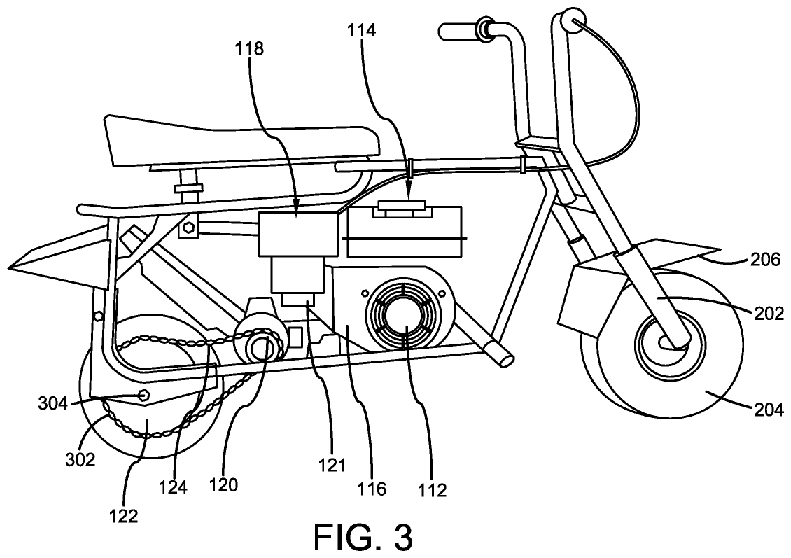

FIG. 3 illustrates a side perspective view of the convertible all-terrain minibike in a wheel-based configuration adapted for operation on firmer terrain such as dirt, gravel, and paved surfaces. In this embodiment, the convertible all-terrain minibike 100 includes the previously described engine 118 and fuel tank 114 mounted to the frame assembly 102, wherein the engine 118 provides the primary source of propulsion.

As shown in FIG. 3, the engine 118 is operatively coupled to the drivetrain system including the centrifugal clutch assembly 121 mounted on an output shaft of the engine 118. The centrifugal clutch assembly 121 is configured to automatically engage upon reaching a predetermined engine speed, thereby transmitting rotational power without requiring manual clutch actuation. In one embodiment, the centrifugal clutch assembly 121 includes or is operatively connected to the drive sprocket 120.

The drive sprocket 120 is mechanically coupled to the driven sprocket 122 via the drive chain or belt 124. The driven sprocket 122 is mounted on a rear axle 304 and is configured to rotate in response to movement of the drive chain or belt 124. The rear axle 304 supports a rear wheel assembly 302, such that rotation of the driven sprocket 122 causes corresponding rotation of the rear wheel assembly 302 to propel the convertible all-terrain minibike 100 forward. The drivetrain can further include a recoil starter assembly 116 and an exhaust system 112 associated with the engine 118, as previously described.

At the forward portion of the convertible all-terrain minibike 100, the front wheel assembly 202 is provided, including the tire 204 rotatably supported by a front fork. The front fender 206 is disposed above the tire 204 and is configured to deflect debris away from the rider and vehicle components during operation.

In operation, the engine 118 drives the centrifugal clutch assembly 121, which in turn rotates the drive sprocket 120. The drive sprocket 120 transfers rotational motion through the drive chain or belt 124 to the driven sprocket 122, thereby rotating the rear wheel assembly 302 to propel the convertible all-terrain minibike 100.

The convertible all-terrain minibike 100 of different embodiments can be provided as a complete assembled vehicle or alternatively as a conversion kit comprising one or more modular components configured for attachment to an existing minibike platform. The modular components can include, but are not limited to, interchangeable rear propulsion systems, such as a rear track assembly or a rear wheel assembly, and interchangeable front terrain-engaging members, such as a front ski assembly or a front wheel assembly.

The convertible all-terrain minibike 100 can be selectively configured by a user to operate on a variety of terrain types, including dirt, gravel, mud, sand, snow, and ice. The conversion between configurations (as shown in FIG. 1-3) can be accomplished by removal and installation of select components using standard fasteners, thereby enabling rapid adaptation without significant structural modification.

In some embodiments, the drivetrain of the convertible all-terrain minibike 100 can include a chain-driven system, as described herein, or alternatively a belt-driven transmission system, depending on user preference or design requirements.

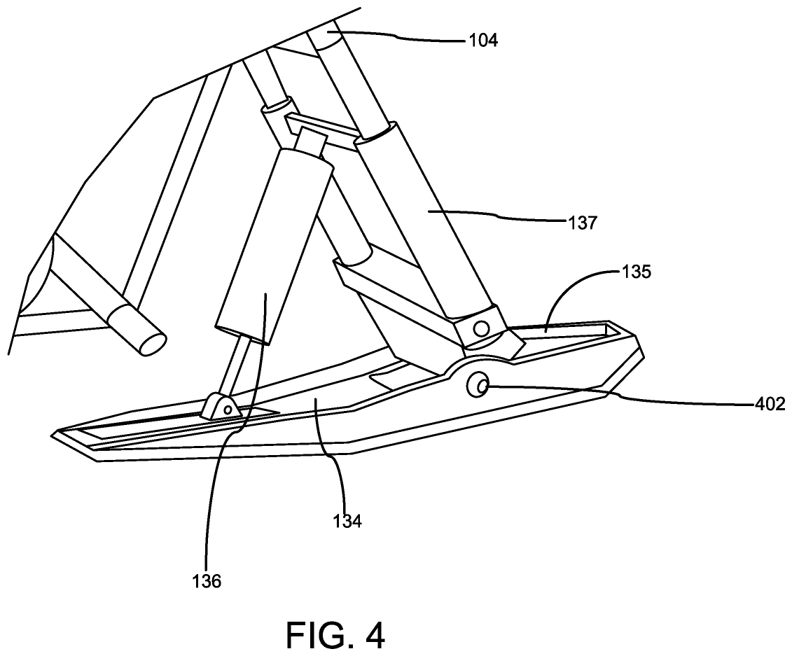

FIG. 4 illustrates an enlarged perspective view of the front portion of the convertible all-terrain minibike of the present invention, showing installation of the front ski assembly, in accordance with the disclosed structure. The front ski assembly 134 is configured to replace a conventional front wheel assembly and to provide improved flotation and steering control when operating on snow, ice, sand, or other soft terrain. The ski assembly 134 is mounted to the front fork 137 enabling the ski 135 to move relative to the fork 137 during steering.

Specifically, the front ski assembly 134 is secured to the front fork 137 using one or more fasteners 402, which can include bolts, nuts, pins, or equivalent fastening elements configured to retain the ski assembly 134 in position during operation while permitting removal when desired. The use of fasteners 402 facilitates a modular configuration in which the ski assembly 134 can be readily detached and replaced with a front wheel assembly.

The shock absorber or stabilizer 136 is operatively coupled, in a rearward orientation, between the front fork 137 and the ski 135. The shock absorber 136 is configured to dampen vertical movement and absorb impacts encountered during operation, thereby improving ride comfort and maintaining consistent contact between the ski 135 and the terrain. The shock absorber 136 further assists in stabilizing the orientation of the ski 135 relative to the front fork 137 during steering maneuvers.

The front fork 137 is removably attached to the handle assembly 104 of the convertible all-terrain minibike 100. Accordingly, the structure and mounting arrangement of the front ski assembly 134 and the front fork 137 enable conversion of the convertible all-terrain minibike 100 for operation on snow, sand, and other low-traction surfaces.

Referring back to FIGS. 1 and 2, the rear track assembly 126 can be removably coupled to the frame assembly 102 using a plurality of fasteners, such as bolts, thereby enabling conversion between a wheel-based configuration and a track-based configuration. In one embodiment, the rear track assembly 126 is secured to the convertible all-terrain minibike 100 using a plurality of mounting bolts not shown positioned at predefined attachment points on the frame assembly 102.

Similar to the removal of front wheel assembly, the rear wheel assembly FIG. 3 can be removed and can include removing the rear axle 304 and disengaging the rear wheel assembly from the frame assembly. Once the rear wheel is removed, the rear track assembly 126 can be positioned relative to the frame assembly 102. Accordingly, the rear track assembly 126 can be quickly and efficiently installed using a limited number of fasteners, thereby enabling a user to convert the convertible all-terrain minibike 100 from a wheel-based configuration to a track-based configuration suitable for operation on snow, mud, sand, or other challenging terrain conditions.

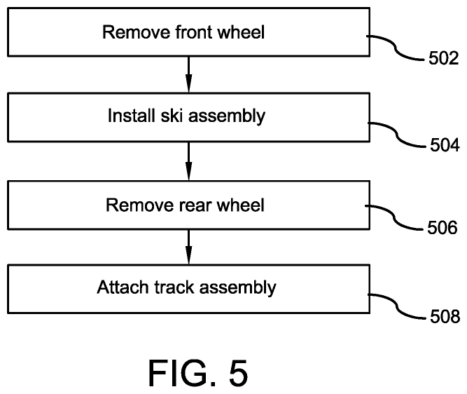

FIG. 5 illustrates a flow diagram depicting steps of converting the convertible all-terrain minibike from a wheel-based configuration to a track and ski-based configuration, in accordance with the disclosed structure. The method can be performed by a user to adapt the convertible all-terrain minibike for operation on snow, mud, sand, or other low-traction terrain. Initially, a front wheel from the convertible all-terrain minibike 100 is removed which can include removal of a front axle and associated fasteners (Step 502). Then, a front ski assembly is installed in place of the removed front wheel (Step 504). The ski assembly is secured to the front fork using one or more fasteners, such as an axle bolt, as described earlier in the disclosure.

The method further includes removing a rear wheel from the convertible all-terrain minibike, which may involve removal of a rear axle and associated mounting components (Step 506). After removal of the rear wheel, a rear track assembly is attached to the convertible all-terrain minibike 100 (Step 508). The rear track assembly can be secured using a plurality of fasteners and can include installation of a drive axle and tensioning of the track belt assembly. In some embodiments, certain steps can be performed in a different order, combined, or supplemented with additional steps, such as installing a shock absorber or adjusting alignment and tension components.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “modular all-terrain minibike”, “convertible minibike system”, “modular minibike apparatus”, and “all-terrain minibike” are interchangeable and refer to the modular all-terrain minibike 100 of the present invention.

Notwithstanding the forgoing, the modular all-terrain minibike 100, 200 of the present invention can be of any suitable configuration as is known in the art without affecting the overall concept of the invention, provided that it accomplishes the above stated objectives. One of ordinary skill in the art will appreciate that the modular all-terrain minibike 100, 200 shown in the FIGS. are for illustrative purposes only, and that many other configurations of the modular all-terrain minibike 100, 200 are well within the scope of the present disclosure. Although the dimensions of the modular all-terrain minibike 100, 200 are important design parameters for user convenience, the modular all-terrain minibike 100, 200 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A convertible all-terrain minibike comprising:
an interchangeable forward terrain-engaging assembly;
a frame assembly;
a seat assembly;
a handlebar assembly;
a power unit; and
an interchangeable rear propulsion system;
wherein said frame assembly constructed from a plurality of welded tubular members;
wherein said seat assembly is mounted to said frame assembly and is configured to support a rider;
wherein said handlebar assembly is positioned at a forward portion of said frame assembly and comprises handle grips to enable a user to control steering and operation of the convertible all-terrain minibike;
wherein said power unit comprises an engine mounted to said frame assembly;
wherein said engine is operatively connected to a drivetrain system including a drive sprocket and a driven sprocket coupled with a drive chain;
wherein said drivetrain system transfers rotational power from said engine to said interchangeable rear propulsion system;
wherein said interchangeable forward terrain-engaging assembly selectively interchangeable between a front wheel assembly and a front ski assembly; and
further wherein the convertible all-terrain minibike selectively operable on snow and at least two other terrain types selected from the group consisting of mud, sand, gravel, dirt, and uneven off-road surfaces.

2. The convertible all-terrain minibike of claim 1, wherein said interchangeable rear propulsion system selectively interchangeable between a rear wheel assembly and a rear track assembly.

3. The convertible all-terrain minibike of claim 2, wherein said rear track assembly comprises a continuous track supported by at least one rear idler wheel and guided by a rear track support including a track tensioner to maintain tension of said rear track assembly during operation.

4. The convertible all-terrain minibike of claim 3, wherein said engine is a gasoline-powered engine and comprises a fuel tank positioned above an engine housing, and wherein said fuel tank is configured to store a supply of liquid fuel for delivery to said engine.

5. The convertible all-terrain minibike of claim 4 further comprising a control cable, wherein said control cable extends from said handlebar assembly to said engine for controlling throttle or braking functions.

6. The convertible all-terrain minibike of claim 5, wherein said seat assembly is positioned along an upper portion of said frame assembly and comprises a spring-supported seat mount that provides cushioning and vibration reduction during operation on uneven off-road surfaces.

7. The convertible all-terrain minibike of claim 1, wherein said front ski assembly comprises a front fork assembly, a shock absorber, and a ski, and wherein said shock absorber is connected in a rearward orientation between said front fork assembly and said ski.

8. A convertible all-terrain minibike comprising:
an interchangeable forward terrain-engaging assembly;
a frame assembly;
a seat assembly;
a handlebar assembly;
a power unit; and
an interchangeable rear propulsion system;
wherein said frame assembly constructed from a plurality of welded tubular members;
wherein said seat assembly is mounted to said frame assembly and is configured to support a rider;
wherein said handlebar assembly is positioned at a forward portion of said frame assembly and comprises handle grips to enable a user to control steering and operation of the convertible all-terrain minibike;
wherein said power unit comprises an engine mounted to said frame assembly;
wherein said engine is operatively connected to a drivetrain system including a drive sprocket and a driven sprocket coupled with a drive chain;
wherein said drivetrain system transfers rotational power from said engine to said interchangeable rear propulsion system;
wherein said interchangeable forward terrain-engaging assembly selectively interchangeable between a front wheel assembly and a front ski assembly;
wherein said front ski assembly comprises a front fork assembly, a shock absorber, and a ski; and
further wherein said shock absorber is connected in a rearward orientation between said front fork assembly and said ski.

9. The convertible all-terrain minibike of claim 8, wherein said interchangeable rear propulsion system selectively interchangeable between a rear wheel assembly and a rear track assembly.

10. The convertible all-terrain minibike of claim 9, wherein said rear track assembly comprises a continuous track supported by at least one rear idler wheel and guided by a rear track support including a track tensioner to maintain tension of said rear track assembly during operation.

11. The convertible all-terrain minibike of claim 10, wherein said engine is a gasoline-powered engine and comprises a fuel tank positioned above an engine housing, and wherein said fuel tank is configured to store a supply of liquid fuel for delivery to said engine.

12. The convertible all-terrain minibike of claim 11 further comprising a control cable, wherein said control cable extends from said handlebar assembly to said engine for controlling throttle or braking functions.

13. The convertible all-terrain minibike of claim 12, wherein said seat assembly is positioned along an upper portion of said frame assembly and comprises a spring-supported seat mount that provides cushioning and vibration reduction during operation on uneven off-road surfaces.

14. The convertible all-terrain minibike of claim 13, wherein the convertible all-terrain minibike selectively operable on snow and at least two other terrain types selected from the group consisting of mud, sand, gravel, dirt, and uneven off-road surfaces.

15. A method of converting an all-terrain minibike for use on different terrain types, the method comprising the steps of:
providing an interchangeable forward terrain-engaging assembly, a frame assembly, a seat assembly, a handlebar assembly, a power unit, and an interchangeable rear propulsion system;
wherein said handlebar assembly is positioned at a forward portion of said frame assembly and comprises handle grips to enable a user to control steering and operation of the convertible all-terrain minibike;
wherein said power unit comprises an engine mounted to said frame assembly;
wherein said engine is operatively connected to a drivetrain system including a drive sprocket and a driven sprocket coupled with a drive chain;
wherein said drivetrain system transfers rotational power from said engine to said interchangeable rear propulsion system;
selectively interchanging said interchangeable forward terrain-engaging assembly between a front wheel assembly and a front ski assembly; and
selectively interchanging said interchangeable rear propulsion system between a rear wheel assembly and a rear track assembly.

16. The method of converting an all-terrain minibike for use on different terrain types of claim 15, wherein said front ski assembly comprises a front fork assembly, a shock absorber, and a ski, and wherein said shock absorber is connected in a rearward orientation between said front fork assembly and said ski.

17. The method of converting an all-terrain minibike for use on different terrain types of claim 16, wherein said rear track assembly comprises a continuous track supported by at least one rear idler wheel and guided by a rear track support including a track tensioner to maintain tension of said rear track assembly during operation.

18. The method of converting an all-terrain minibike for use on different terrain types of claim 17 further comprising a control cable, wherein said control cable extends from said handlebar assembly to said engine for controlling throttle or braking functions.

19. The method of converting an all-terrain minibike for use on different terrain types of claim 17, wherein said seat assembly is positioned along an upper portion of said frame assembly and comprises a spring-supported seat mount that provides cushioning and vibration reduction during operation on uneven off-road surfaces.

20. The method of converting an all-terrain minibike for use on different terrain types of claim 16, wherein the convertible all-terrain minibike selectively operable on snow and at least two other terrain types selected from the group consisting of mud, sand, gravel, dirt, and uneven off-road surfaces.
